(19) United States
(12) Patent Application Publication
(10) Pub. No.: US 2021/0062769 A1
(43) Pub. Date: Mar. 4, 2021

(54) Device for Mounting a Canister

(71) Applicant: AISAN KOGYO KABUSHIKI KAISHA, Obu-shi (JP)

(72) Inventors: Yoshihiro YASUDA, Toyota-shi (JP); Norihiro KONDO, Toyota-shi (JP)

(73) Assignee: AISAN KOGYO KABUSHIKI KAISHA, Obu-shi (JP)

(21) Appl. No.: 17/002,892

(22) Filed: Aug. 26, 2020

(30) Foreign Application Priority Data
Aug. 27, 2019 (JP) 2019-154489

(51) Int. Cl. F02M 25/08

(52) U.S. Cl. CPC F02M 25/0854

(57) ABSTRACT

A device for mounting a canister includes an externally threaded element, a rod element, a canister, and an internally threaded element screwed. The externally threaded element is located on a vehicle body member. The rod element is also located on the vehicle body member and extends parallel to the externally threaded element. The canister includes a casing. The casing includes a mounting portion and a retaining portion. The mounting portion defines an insertion hole configured to allow the externally threaded element to be inserted thereinto. The retaining portion includes a retention area. The retaining portion is configured to hold onto the rod element when the rod element has been inserted through the retention area. The internally threaded element is screwed on the externally threaded element after the externally threaded element has been inserted through the insertion hole.

### CROSS-REFERENCE TO RELATED APPLICATIONS

This application claims priority to a Japanese Patent Application serial number 2019-154489 filed Aug. 27, 2019, which is hereby incorporated herein by reference in its entirety for all purposes.

### BACKGROUND

The present disclosure relates to canister mounting devices, and more specifically to devices for mounting canisters that adsorb fuel vapor on vehicle body members.

A conventional canister mounting device includes hook portions provided on the canister casing and a bolt hole defined in the casing. The vehicle body member includes locking holes and a bolt hole associated with the hook portions and the bolt hole, respectively, of the canister casing. The canister can be temporarily fixed to the vehicle body member by fitting the hook portions of the casing into the locking holes and then sliding the canister laterally to cause the hook portions to engage with the locking holes. In this position, the bolt hole in the canister casing is aligned with the bolt hole in the vehicle body member. The canister can be fastened to the vehicle body member by tightening a nut on the bolt inserted through the bolt hole.

### SUMMARY

A device for mounting a canister may include an externally threaded element, a rod element, a canister, and an internally threaded element screwed. The externally threaded element may be located on a vehicle body member. The rod element may also be located on the vehicle body member and may extend parallel to the externally threaded element. The canister may include a casing. The casing may include a mounting portion and a retaining portion. The mounting portion may define an insertion hole structured to allow the externally threaded element to be inserted thereinto. The retaining portion may have a retention area. The retaining portion may be structured to hold onto the rod element when the rod element has been inserted through the retention area. The internally threaded element may be screwed on the externally threaded element after the externally threaded element has been inserted through the insertion hole.

### BRIEF DESCRIPTION OF THE DRAWINGS

FIG. 1 is a side view of a canister mounting device according to one embodiment.

FIG. 2 is a cross-sectional view of the canister mounting device of FIG. 1.

FIG. 3 is a cross-sectional view taken along the line III-III in FIG. 2.

FIG. 4 is a cross-sectional view taken along the line IV-IV in FIG. 2.

FIG. 5 is a perspective view of a canister.

FIG. 6 is a plan view of a bracket of the casing of FIG. 5.

FIG. 7 is a cross-sectional view taken along the line VII-VII of FIG. 6.

FIG. 8 is a cross-sectional view taken along the line VIII-VIII in FIG. 7.

FIG. 9 is a side view of the canister of FIG. 5 immediately before the mounting.

FIG. 10 is a side view of the temporarily fixed canister of FIG. 5.

FIG. 11 is a plan view of a retaining portion according to another embodiment.

FIG. 12 is a plan view of a retaining portion according to yet another embodiment.

### DETAILED DESCRIPTION OF EMBODIMENTS

A mounting process with the conventional mounting device mentioned above requires fitting of the hook portions into the respective locking holes as well as a subsequent movement of the canister in a lateral direction that is different from the fitting direction. The process further requires inserting the bolt through the bolt holes defined in the canister casing and the vehicle body member, after the bolt holes are aligned. Therefore, the process of mounting the canister is complex, and the configuration of the mounting device tends to be complicated. Thus, there is a need to facilitate the mounting process and to simplify the device configuration. Embodiments described herein simplify the mounting process.

Embodiments will now be described below with reference to the drawings.

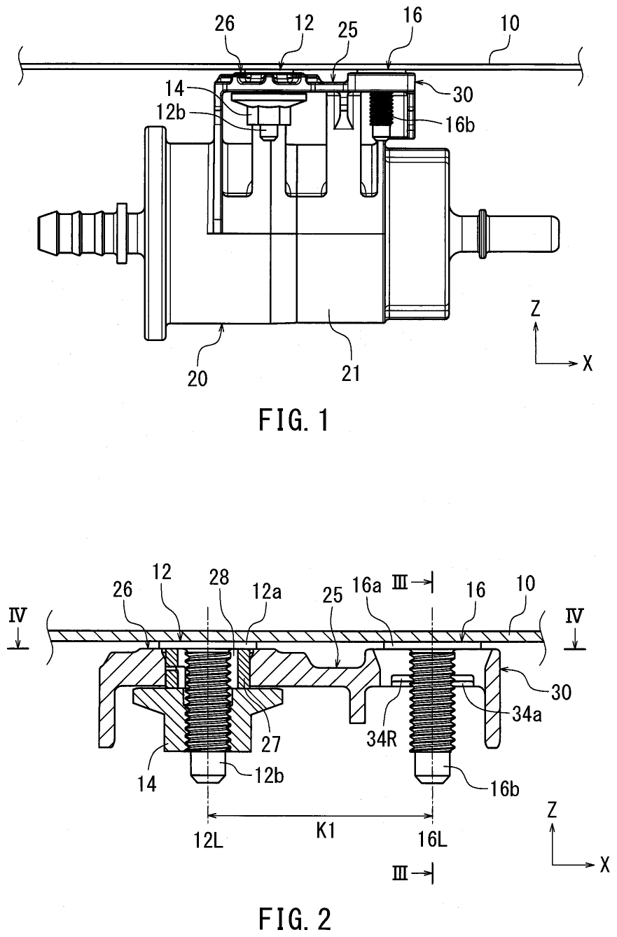

Referring to FIG. 1, a vehicle, such as an automobile, may be provided with a device for mounting the canister on the lower side of the floor or underbody structure of the vehicle. For convenience, the orthogonal axes X, Y, and Z are introduced and illustrated in the drawings to represent the forward, rightward, and upward directions, respectively, of the vehicle. The descriptions below may use directional terms based on the position and orientation of the canister and the orthogonal axes X, Y, and Z shown in the drawings. However, the mounting position of the canister and the direction of moving the canister in the mounting process is not limited to those shown.

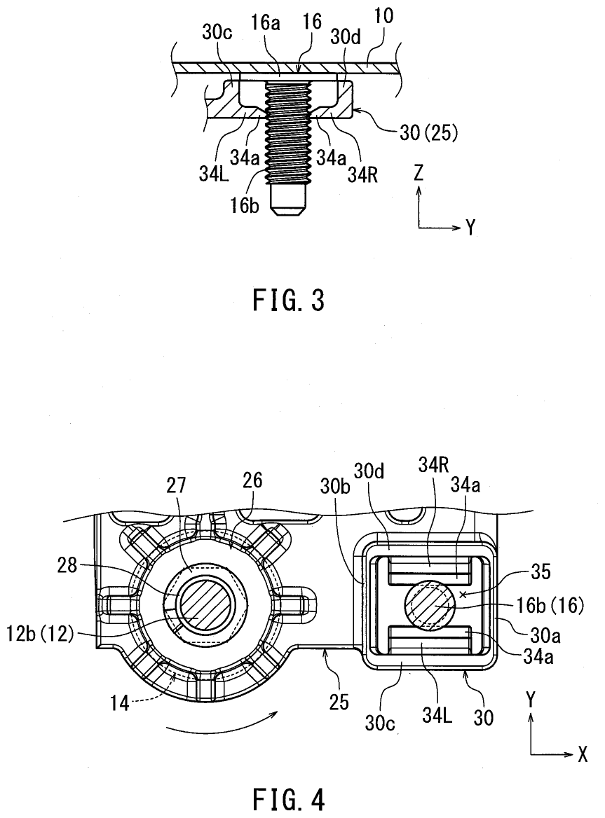

Referring to FIGS. 2 and 3, a fastening bolt 12 is provided on the lower side of the floor 10 or other body member of the vehicle. For example, the fastening bolt 12 is a metal bolt having a flange or head 12a and a threaded shaft 12b extending downward from the head 12a. The head 12a is joined to the lower side of the floor 10 by welding or the like. A nut 14 is screwed and tightened onto the threaded shaft 12b. For example, the nut 14 is a hexagon nut with a flange.

On the lower side of the floor 10, a temporary fixing bolt 16 is provided. Bolt 16 is oriented parallel to the fastening bolt 12. In particular, central axes 12L, 16L of bolts 12, 16, respectively, are oriented parallel to each other. In this embodiment, the temporary fixing bolt 16 is a metal bolt having a flange or head 16a and a threaded shaft 16b extending downward from the head 16a. The head 16a is joined to the lower side of the floor 10 by welding or other suitable joining method. The temporary fixing bolt 16 may be of the same type as the fastening bolt 12. The fastening bolt 12 and the temporary fixing bolt 16 are spaced apart a distance or interval K1 measured horizontally between axes 12L, 16L. For convenience, the temporary fixing bolt 16 will be described hereafter as positioned on the front side of the fastening bolt 12.

The fastening bolt 12 may be replaced by any externally threaded element, and the nut 14 by any internally threaded element that can mate with the externally threaded element. The temporary fixing bolt 16 may be any rod element.

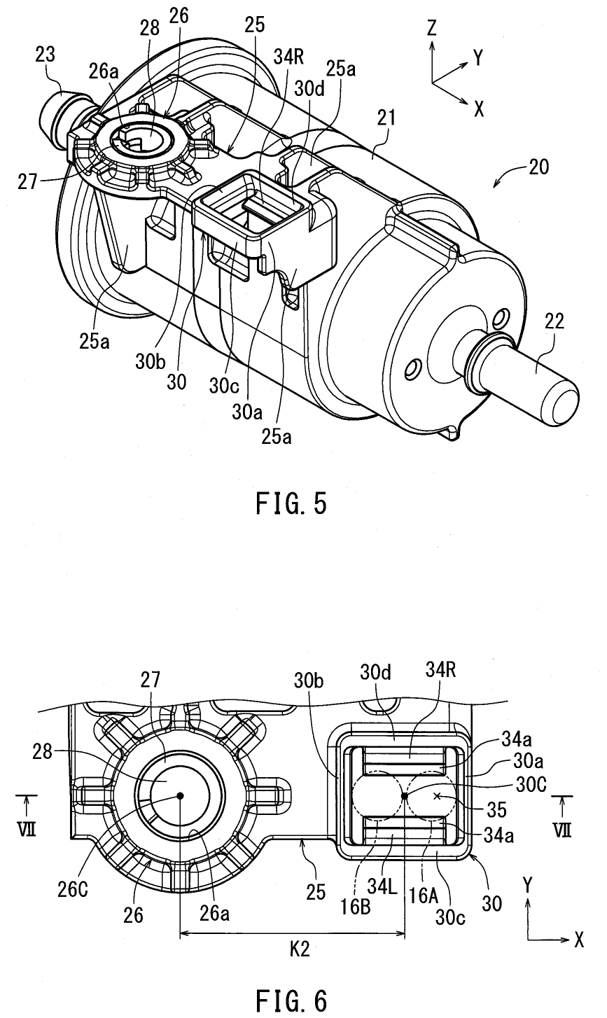

Referring now to FIG. 5, the canister 20 adsorbs fuel vapor generated in a fuel tank installed in the vehicle. The canister 20 may be a main canister, a sub-canister, or an auxiliary canister. In general, a sub-canister may be connected in series with a main canister (not shown) and may adsorb any fuel vapor that was not adsorbed by the main canister.

The canister 20 includes a casing 21, which is a hollow container and may be generally cylindrical. In this embodiment, the casing 21 is oriented such that the flow direction is horizontal in the front-rear direction. The casing 21 contains an adsorbent material, such as granular or pelletized activated carbon, that adsorbs and desorbs fuel vapor. The front end of the casing 21 includes an atmospheric port 22. The rear end of the casing 21 includes a connection port 23 to which a pipe or tube can be connected from the fuel tank or a main canister.

Referring to FIGS. 5 and 6, the casing 21 includes an integrated bracket 25 for mounting on the vehicle floor. For example, the bracket 25 may be positioned on the upper left of the casing 21. The bracket 25 includes a horizontal, generally planar base supported on the casing 21 by support ribs 25a. The bracket 25 is positioned higher than the casing 21 (see FIG. 1). The bracket 25 generally includes a mounting portion 26 and a retaining portion 30.

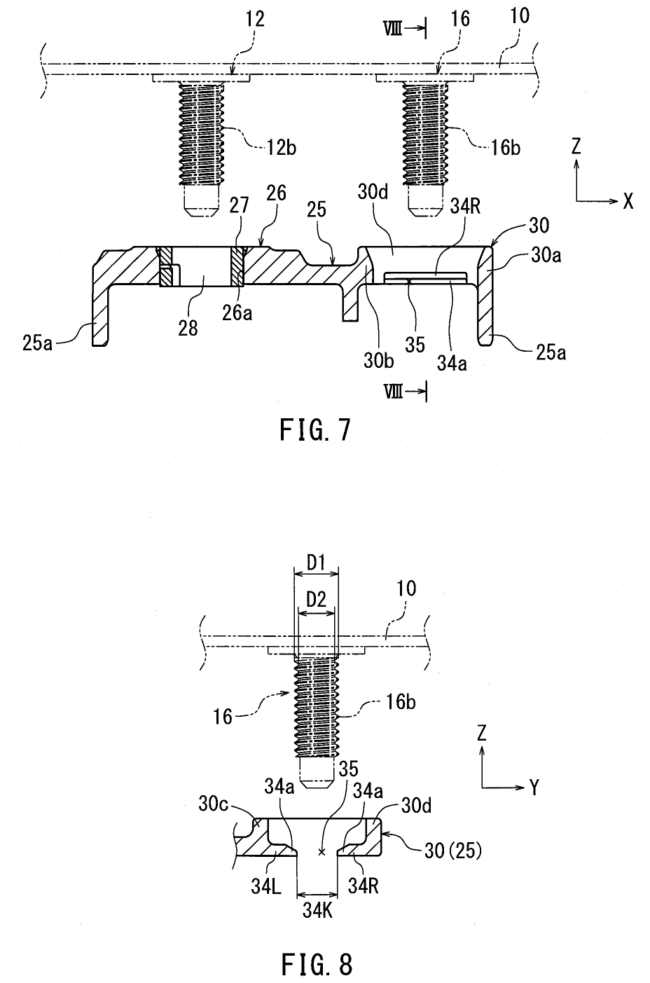

The mounting portion 26 includes a circular through hole 26a extending vertically therethrough (see FIGS. 6 and 7). The mounting portion 26 may be formed as a boss-like feature protruding from the base. A C-shaped metal collar 27 is be press-fitted into the through hole 26a. The collar 27 defines an insertion hole 28 through which the threaded shaft 12b of the fastening bolt 12 is inserted (see FIG. 2). The insertion hole 28 has an inner diameter slightly larger than the thread diameter (at crests) of the threaded shaft 12b of the fastening bolt 12.

The retaining portion 30 is positioned horizontally adjacent to the mounting portion 26. For example, the retaining portion 30 may be located on the front side of the mounting portion 26. The retaining portion 30 includes a rectangular frame having a rectangular opening that extends vertically therethrough. The retaining portion 30 includes a front side portion 30a, a rear side portion 30b, a left side portion 30c, and a right side portion 30d.

Referring now to FIGS. 6 to 8, the retaining portion 30 includes locking tabs or blades 34L, 34R extending inwardly from the inner surfaces of the left and right side portions 30c, 30d of the frame. The locking tabs 34L, 34R are elongate and extend in the front-rear direction along the left and right side portions 30c, 30d. The locking tabs 34L, 34R are positioned at the lower end of the left and right side portions 30c, 30d. The locking tabs 34L, 34R are aligned and extend symmetrically toward each other.

Referring to FIGS. 3 and 8, each of the locking tabs 34L and 34R includes, at the distal end, a claw edge 34a with the thickness (measured parallel to the axis 16L of the temporary fixing bolt 16) that gradually decreases moving toward the tip. In other words, the claw edge 34a has a tapered cross section that intersects the elongated direction (the front-rear direction) of the locking tabs 34L, 34R. The claw edge 34a has an upper surface that gradually lowers moving toward the tip. The claw edge 34a is engageable with the threaded shaft 16b of the temporary fixing bolt 16, for instance by elastic and/or plastic deformation. The portions of the locking tabs 34L, 34R other than the claw edge 34a have a strength such that they do not break when the temporary fixing bolt 16 is temporarily fixed.

Referring to FIGS. 4 and 6, the edges of the locking tabs 34L, 34R extend parallel to the front-rear direction. The direction of the edges of the locking tabs 34L, 34R corresponds to the direction of arrangement of the fastening bolt 12 and the temporary fixing bolt 16. The locking tabs 34L, 34R are spaced from each other, thereby defining an insertion slot 35 into which the threaded shaft 16b of the temporary fixing bolt 16 is inserted. The insertion slot 35 extends in the front-rear direction. The insertion slot 35 has a retention area, extending from the foremost position 16A to the rearmost position 16B, at which the threaded shaft 16b of the temporary fixing bolt 16 is inserted. The canister can be retained when the threaded shaft 16b of the temporary fixing bolt 16 is inserted anywhere within the retention area. The retention area extends linearly in the front-rear direction. The locking tabs 34L, 34R are separated from the front side portion 30a and the rear side portion 30b with gaps.

As shown in FIG. 8, the distance or interval 34K measured between the claw edges 34a of the locking tabs 34L, 34R is smaller than the thread crest diameter (or major diameter) D1 of the threaded shaft 16b of the temporary fixing bolt 16. The interval 34K may be substantially equal to the thread root diameter (or minor diameter) D2 of the threaded shaft 16b of the temporary fixing bolt 16. The distance K2 (FIG. 6) measured horizontally between the center 30C of the retaining portion 30 and the center 26C of the mounting portion 26 is approximately equal to the interval K1 (FIG. 2) between the axis 12L of the fastening bolt 12 and the axis 16L of the temporary fixing bolt 16.

A process of mounting the canister 20 to the floor 10 will be described.

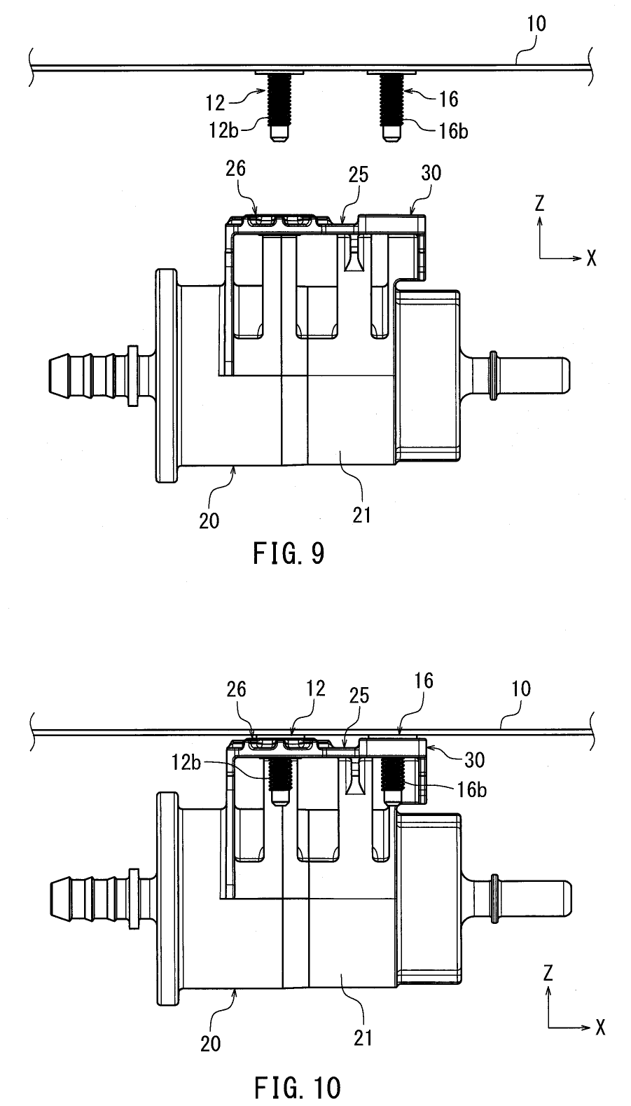

Step 1. As shown in FIGS. 7 and 9, the canister 20 is held to face the floor 10, such that the mounting portion 26 of the bracket 25 of the casing 21 is aligned with the fastening bolt 12 on the floor 10, and such that the retaining portion 30 is aligned with the temporary fixing bolt 16.

Step 2. As shown in FIGS. 3 and 10, the canister 20 is then moved upward so that the threaded shaft 12b of the fastening bolt 12 is inserted into the insertion hole 28 of the mounting portion 26, and the threaded shaft 16b of the temporary fixing bolt 16 is inserted between the engaging claws 34L, 34R of the retaining portion 30. The canister 20 may be moved until the bracket 25 is in contact with or close to the floor 10. During the movement of the canister 20, the claw edges 34a of the locking tabs 34L, 34R rub over the crests of the threaded shaft 16b of the temporary fixing bolt 16, while being elastically and/or plastically deformed. The claw edges 34a of the locking tabs 34L, 34R are locked to the threaded shaft 16b at the final height. As a result, the canister 20 is temporarily fixed to the floor 10.

Step 3. As shown in FIGS. 1 and 2, the nut 14 is tightened onto the fastening bolt 12 that has been inserted through the insertion hole 28 of the mounting portion 26. As a result, the canister 20 is fastened, that is, finally mounted to the floor 10.

The embodiments described above offer the potential for at least the following advantages.

The fastening bolt 12 can be inserted into the insertion hole 28 of the mounting portion 26 of the casing 21 while the retaining portion 30 of the casing 21 is retained by the temporary fixing bolt 16. This allows the canister 20 to be temporarily fixed to the floor 10. Further, the canister 20 is fastened, that is, finally mounted to the floor 10 by tightening the nut 14 to the fastening bolt 12 that is inserted through the insertion hole 28. Therefore, the canister 20 can be temporarily fixed to the floor 10, without the need to move the casing 21 in a lateral direction, a direction different from the insertion direction.

Once the canister 20 is temporarily fixed, the canister 20 can be finally mounted to the floor 10 by simply tightening the nut 14 onto the fastening bolt 12, without needing to tighten another nut onto the temporary fixing bolt 16. The canister 20 can thus be more easily mounted.

Since it is not necessary to laterally move the casing 21 in order to temporarily fix the canister 20, the configuration of the device can be simplified.

The temporary fixing bolt 16 has a threaded shaft 16a, and the retaining portion 30 has locking blades or tabs 34L, 34R that engage with the threaded shaft 16a. The locking tabs 34L, 34R of the retaining portion 30 engaged with the threaded shaft 16a of the temporary fixing bolt 16 allow the canister 20 to be temporarily fixed to the floor 10 in a reliable manner.

The locking tabs 34L, 34R include claw edges 34a that gradually become thinner moving toward the tip, i.e. the claw edges 34a have a smaller dimension measured parallel to the axis 16L of the threaded shaft 16a of the temporary fixing bolt 16. Therefore, the claw edges 34a of the locking tabs 34L, 34R engage with the threaded shaft 16a of the temporary fixing bolt 16 in a biting manner. This allows the retaining portion 30 to firmly hold the temporary fixing bolt 16.

The claw edges 34a of the locking tabs 34L, 34R of the retaining portion 30 are structured such that they can not only be retained by the threaded shaft 16a of the temporary fixing bolt 16 but also serves as an abutting or stopper portion that blocks the threaded shaft 16a. For example, when the nut 14 is screwed counterclockwise in the plan view of FIG. 4 (in the direction of the arrow in FIG. 4), the claw edge 34a of the right locking tab 34R is situated such that it prevents rotation of the casing 21. The claw edge 34a of the right locking tab 34R therefore comes into contact with the threaded shaft 16a of the temporary fixing bolt 16, so as to prevent the canister 20 from rotating while the nut 14 is being screwed.

The retaining portion 30 has a retention area that extends linearly in the direction of arrangement of the fastening bolt 12 and the temporary fixing bolt 16. Thus, even if the distance K1 between the fastening bolt 12 and the temporary fixing bolt 16 varies, the retaining portion 30 can properly hold on the threaded shaft 16a of the temporary fixing bolt 16.

When the temporary fixing bolt 16 is of the same type as the fastening bolt 12, the cost can be reduced as compared with the case where different types of bolts are used.

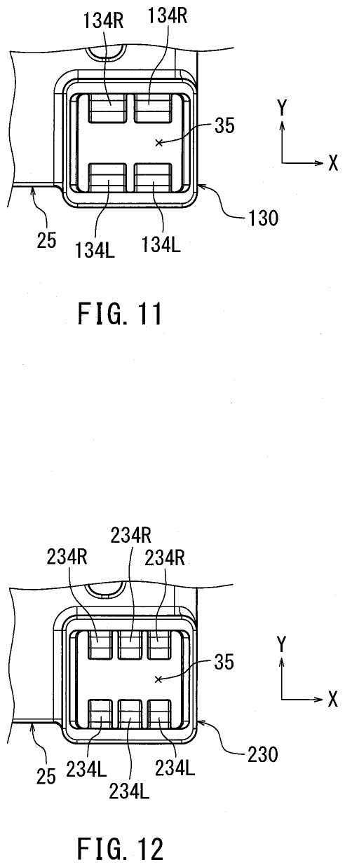

Referring to FIGS. 11 and 12, which depict other embodiments, the retaining portion 30 can be modified in various ways.

As shown in FIG. 11, the retaining portion 130 may be divided into two left and right parts by splitting the locking tabs 34L, 34R of the retaining portion 30 of the embodiment of FIG. 6, so as to form two pairs of locking tabs 134L, 134R.

As shown in FIG. 12, the retaining portion 230 may be divided into three parts by splitting the locking tabs 34L, 34R of the retaining portion 30 in the embodiment of FIG. 6 into three left and right parts, so as to form three pairs of locking tabs 234L, 234R.

The vehicle body member may be a member other than the floor 10.

The fastening bolt 12 and/or the retaining bolt 16 may be any externally threaded fastener elements, for example hexagonal-headed bolts or stud bolts.

The nut 14 may be any internally threaded fastener element, for example a hexagonal nut or a cap nut.

In other embodiments, the retaining bolt 16 may be replaced by any rod element such as a pin. The rod element may be press-fitted, friction-fitted, etc. into the retaining portion to temporarily fix the canister to the vehicle body member.

The externally threaded element and/or the mounting portion are not limited to one, and may be provided in more than one. Likewise, the rod element and/or the retaining portion are not limited to one, and may be provided in more than one.

The locking tabs 34L, 34R may be replaced with an annular blade, a C-shaped blade, or an annular arrangement of tabs.

The locking tabs 34L, 34R are not limited to being arranged on the opposite sides, but may both be arranged on the same side or provided as only a single locking tab.

While specific embodiments has been described above, it will be understood by those skilled in the art that various modifications may be made and equivalents may be substituted for elements thereof without departing from the scope of the disclosure.

What is claimed is:

1. A canister mounting device, comprising:
an externally threaded element on a vehicle body member;
a rod element on the vehicle body member extending substantially parallel to the externally threaded element;
a canister comprising a casing, the casing comprising:
a mounting portion, wherein the mounting portion defines an insertion hole through which the externally threaded element is inserted; and
a retaining portion, wherein the retaining portion has an retention area, and the retaining portion holds onto the rod element inserted through the retention area; and
an internally threaded element screwed on the externally threaded element that is inserted through the insertion hole.

2. The device according to claim 1, wherein:
the rod element comprises a threaded shaft; and
the retaining portion comprises a first locking tab, wherein the first locking tab is locked by the threaded shaft.

3. The device according to claim 2, wherein the first locking tab comprises a gradually thinning claw edge.

4. The device according to claim 2, wherein the retaining portion further comprises a second locking tab.

5. The device according to claim 4, wherein the first and second locking tabs are located on opposite sides of the rod element.

6. The device according to claim 4, wherein a distance between the first and second locking tabs is less than a diameter of the insertion hole.

7. The device according to claim 4, wherein a distance between the first and second locking tabs is smaller than an outer diameter of the threaded shaft.

8. The device according to claim 1, wherein the retaining portion has a stopper portion blocking the rod element and configured to prevent rotation of the casing when the internally threaded element is rotated.

9. The device according to claim 1, wherein the retention area of the retaining portion extends linearly in an arrangement direction of the externally threaded element and the rod element.

10. The device according to claim 1, wherein a length of the retention area is greater than a length of the insertion hole as measured in an arrangement direction of the externally threaded element and the rod element.

11. The device according to claim 1, wherein a width of the retention area is less than a width of the insertion hole as measured in a direction perpendicular to an arrangement direction of the externally threaded element and the rod element.

12. The device according to claim 1, wherein the retention area is larger than the insertion hole.

13. The device according to claim 1, wherein the externally threaded element does not engage the insertion hole.

14. The device according to claim 1, wherein a diameter of the externally threaded element is substantially the same as a diameter of the rod element.

15. The device according to claim 1, wherein the externally threaded element and the rod element are oriented substantially parallel in a direction perpendicular to an arrangement direction of the externally threaded element and the rod element.
